(19) United States
(12) Patent Application Publication
(10) Pub. No.: US 2019/0372650 A1
(43) Pub. Date: Dec. 5, 2019

(54) RELAY APPARATUS AND RELAY METHOD

(71) Applicant: SoftBank Corp., Tokyo (JP)

(72) Inventors: Takanori TAKII, Tokyo (JP); Masahiko NANRI, Tokyo (JP); Takayuki YOSHIMURA, Tokyo (JP); Masanori NOMACHI, Tokyo (JP); Jumpei TAKAGI, Tokyo (JP)

(21) Appl. No.: 15/508,906

(22) PCT Filed: Dec. 14, 2016
(86) PCT No.: PCT/JP2016/087184

§ 371 Date: Mar. 3, 2017

(30) Foreign Application Priority Data
Oct. 20, 2016 (JP) 2016-205691

(51) Int. Cl. H04B 7/08; H04B 7/155; H04W 24/08

(52) U.S. Cl. CPC H04B 7/086; H04W 24/08; H04B 7/155

(57) ABSTRACT

Communication quality in both transmission and reception is enhanced when a relay apparatus that communicates with a plurality of base stations in a plurality of different frequency bands relays communication between a terminal device and a macro cell base station. A relay apparatus 20 for relaying communication between a terminal device 10a and a macro cell base station includes: an antenna group constituted of a plurality of antennas 25 for transmitting and receiving a signal to and from a plurality of macro cell base stations in a plurality of different frequency bands; a measurement unit 203 that measures a reception status of a signal received from one macro cell base station; a reception antenna selection unit 204 that selects a plurality of antennas 25 on the basis of the measured reception status; a receiver 205 that receives the signal from the one macro cell base station by using the selected plurality of antennas 25; and a transmitter 206 that transmits the signal to the one macro cell base station by using the same combination of antennas 25 as the plurality of antennas used to receive the signal.

### TECHNICAL FIELD

The present invention relates to a relay apparatus and relay method for relaying communication between a terminal device(s) and a macro cell base station(s).

### BACKGROUND ART

It is conventionally known that a relay apparatus is interposed between a terminal device(s) and a macro cell base station(s) in order to secure a communication path between the terminal device(s) and the macro cell base station(s) within a building.

Regarding this, PTL 1 discloses a radio communication system including a relay station that relays communication between a terminal device(s) and a base station(s) and communicates with a plurality of base stations in a plurality of different frequency bands by using a plurality of antennas.

### CITATION LIST

### Patent Literature

PTL 1: Japanese Unexamined Patent Application Publication (Translation of PCT Application) No. 2015-502056

### SUMMARY OF THE INVENTION

### Technical Problem

Under this circumstance, according to the LTE (Long Term Evolution) TDD (Time Division Duplex) system, the same frequency is used for downlink indicative of transmission of a signal from a base station to a relay station (reception of the signal by the relay apparatus) and uplink indicative of transmission of the signal from the relay station to the base station. So, if an antenna used for the downlink is used also for the uplink, optimal weighting of the antenna for the downlink can be also directly applied to the uplink.

However, with the radio communication system equipped with the relay station as described above, a common antenna is not necessarily used for both the downlink and the uplink. So, when different antennas are used for the downlink and the uplink, the optimal weighting of the antenna for the downlink cannot be applied to weighting for the uplink and, therefore, there is a possibility that the relay station which communicates with a plurality of base stations in a plurality of different frequency bands may not be able to maintain specified communication quality. Accordingly, if the specified communication quality at the relay station cannot be maintained, there is fear that the communication quality including communication speeds and communication reliability of the entire communication system may degrade.

The present invention was devised in light of the above-described circumstances and it is an object of the invention to provide a relay apparatus and relay method capable of enhancing communication quality in both transmission and reception when a relay apparatus that communicates with a plurality of base stations in a plurality of different frequency bands relays communication between a terminal device and a macro cell base station.

### Solution to Problem

As a result of ardent studies on selection of antennas to enhance the communication quality of the relay apparatus in light of the above-described object, the inventors of the present invention have focused attention on the fact that a combination of antennas for a relay apparatus which provides a preferred signal reception status in a specified frequency can also create a preferred signal transmission status in the signal transmission using the same frequency; and, therefore, they have come to think of the present invention.

A relay apparatus according to an aspect of the present invention is a relay apparatus for relaying communication between a terminal device and a macro cell base station, wherein the relay apparatus includes: an antenna group constituted of a plurality of selectable antennas for transmitting and receiving a signal to and from a plurality of macro cell base stations in a plurality of different frequency bands; a measurement unit that measures a reception status of a signal received from one macro cell base station from among the plurality of macro cell base stations while changing a combination of the plurality of antennas to be used; a reception antenna selection unit that selects the plurality of antennas to be used to receive the signal from the one macro cell base station on the basis of the measured reception status; a receiver that receives the signal from the one macro cell base station by using the selected plurality of antennas; and a transmitter that transmits the signal to the one macro cell base station by using the same combination of antennas as the plurality of antennas used to receive the signal.

With the above-described relay apparatus, the reception antenna selection unit may prioritize selection of an antenna, whose reception intensity of the signal from the macro cell base station is high, from among the antenna group.

A relay method according to an aspect of the present invention is a relay method for relaying communication between a terminal device and a macro cell base station, wherein the relay method includes the steps of: while changing a combination of a plurality of antennas to be used from among an antenna group constituted of a plurality of selectable antennas for transmitting and receiving a signal to and from a plurality of macro cell base stations in a plurality of different frequency bands, measuring a reception status of a signal received from one macro cell base station from among the plurality of macro cell base stations; selecting the plurality of antennas to be used to receive the signal from the one macro cell base station on the basis of the measured reception status; receiving the signal from the one macro cell base station by using the selected plurality of antennas; and transmitting the signal to the one macro cell base station by using the same combination of antennas as the plurality of antennas used to receive the signal.

### Advantageous Effects of the Invention

According to the present invention, communication quality in both transmission and reception can be enhanced when a relay apparatus that communicates with a plurality of base stations in a plurality of different frequency bands relays communication between a terminal device and a macro cell base station.

### BRIEF DESCRIPTION OF DRAWINGS

FIG. 1 is a configuration diagram of a mobile body communication system according to an embodiment;

FIG. 2 is a configuration diagram of a relay apparatus according to an embodiment;

FIG. 3 is a sequence diagram for explaining a procedure for reception antenna selection processing according to an embodiment; and

FIG. 4 is a conceptual diagram for explaining the reception antenna selection processing according to an embodiment.

### DESCRIPTION OF EMBODIMENTS

An embodiment of the present invention will be explained below with reference to the attached drawings. However, the embodiment explained below will be given merely for the purpose of illustration and there is no intention to exclude application of various variations or techniques which are not clearly specified below. In other words, the present invention can be implemented with various modifications without the scope departing from the gist of the invention. Furthermore, the same or similar reference numerals are assigned to, and represent, the same or similar elements in the illustrations in the series of drawings.

### [Configuration of Mobile Body Communication System]

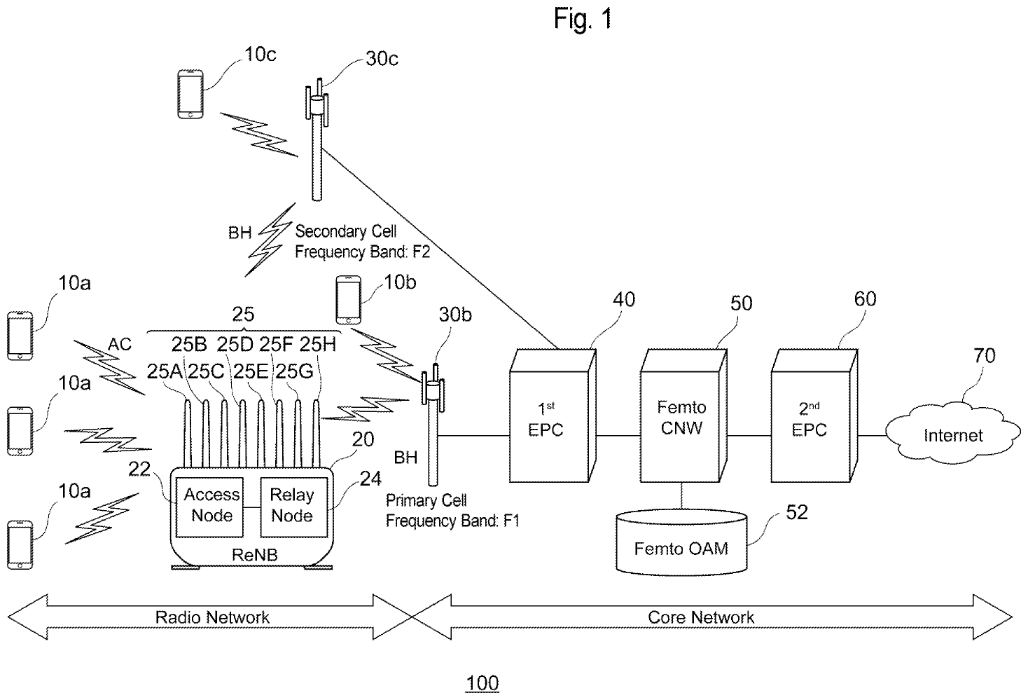

FIG. 1 is a configuration diagram of a mobile body communication system including a femto cell base station (relay apparatus) according to an embodiment. A mobile body communication system 100 according to this embodiment is illustratively a mobile body communication system according to the LTE system whose standards are set in conformity with 3GPP and includes a radio network and a core network. The configuration of the radio network and the configuration of the core network will be explained sequentially below.

### (Configuration of Radio Network)

Referring to FIG. 1, the mobile body communication system 100 includes terminal devices 10, a relay apparatus 20, and donor base stations (macro cell base stations) 30 as the configuration of the radio network. Incidentally, the radio network is called E-UTRAN (Evolved Universal Terrestrial Radio Access Network) according to the LTE system.

The terminal device 10 is a device that communicates with the relay apparatus 20 or the donor base station 30. The terminal device 10 is a mobile portable communication terminal such as a smartphone or a cell phone and is also called UE (User Equipment). FIG. 1 illustrates: terminal devices 10a that exist in a service area of a cell (the range capable of communication) formed by the relay apparatus 20 and are connected to the relay apparatus 20; a terminal device 10b that exists in a service area of a cell formed by a donor base station 30b and is connected to the donor base station 30b; and a terminal device 10c that exists in a service area of a cell formed by a donor base station 30c and is connected to the donor base station 30c. The terminal devices 10a, the terminal device 10b, and the terminal device 10c will be hereinafter sometimes collectively referred to as the terminal device 10. The donor base station 30b and the donor base station 30c will be hereinafter sometimes collectively referred to as the donor base station 30.

The relay apparatus 20 can be moved and is an apparatus for relaying communication between the terminal devices 10a and the donor base station 30. The relay apparatus 20 communicates with a plurality of donor base stations 30 in a plurality of different frequency bands. For example, the relay apparatus 20 communicates with the donor base station 30b, which is a primary cell, in a frequency band F1 and communicates with the donor base station 30c, which is a secondary cell, in a frequency band F2. The relay apparatus 20 is also called a ReNB (Repeater type eNodeB) and constitutes one node in the radio network. The frequency band F1 and the frequency band F2 will be hereinafter sometimes collectively referred to as the frequency band F.

The relay apparatus 20 is configured by including an access node 22 and a relay node 24.

The access node 22 establishes radio communication with the terminal devices 10a and provides the terminal devices 10a with the packet communication services (such as voice packet communication services and multimedia services). The access node 22 is also called a femto base station. Radio communication between the access node 22 and the terminal devices 10a is also called an access link (AC: Access Link). The cell formed by the access node 22 and its cell size is of a smaller scale than that of the donor base station 30 and constructs a communication area with a radius ranging from several meters to tens of meters.

The access node 22 establishes radio communication with the donor base station 30 via the relay node 24. The relay node 24 is also called CPE (Customer Premises Equipment). Radio communication between the relay node 24 and the donor base station 30 is also called backhaul (BH: Backhaul).

Incidentally, the access node 22 and the relay node 24 may be configured as separate nodes. When they are configured as the separate nodes, the relay node 24 serves the role of the relay apparatus according to the present invention.

The relay apparatus 20 includes an antenna group 25 constituted of a plurality of selectable antennas 25A to 25H for transmitting and receiving a signal to and from the plurality of macro cell base stations 30b, 30c in the plurality of different frequency bands F1, F2. For example, the relay apparatus 20 includes eight antennas 25A to 25H and transmits and receives the signal while changing a combination of the eight antennas 25A to 25H. For example, the eight antennas 25 operate as reception antennas and receive the signal from the donor base station 30. Specifically speaking, the relay apparatus 20 is configured so that when the relay apparatus selects the antennas 25A, 25C, 25D, 25G from the antenna group 25 on the basis of the signal reception status of each antenna 25A to 25H, it also uses the antennas 25A, 25C, 25D, 25G to transmit the signal. Incidentally, it is only necessary to set a plural number of antennas to be included in the antenna group 25 and there is no limitation on that number.

The donor base station 30 establishes radio communication with the access node 22 via the relay node 24. The donor base station 30 is also called a Donor eNB (Donor eNode B). The donor base station 30 constructs a communication area with a radius ranging from hundreds of meters to tens of kilometers.

### (Configuration of Core Network)

Referring to FIG. 1, the mobile body communication system 100 includes a first core network EPC (Evolved Packet Core) 40, a femto core network 50 (communication control server), and a second core network EPC 60 as the configuration of the core network. Incidentally, this embodiment is explained as including the first core network EPC 40 and the second core network EPC 60; however, the core network may be configured from one core network EPC.

The first core network EPC 40 is connected to, for example, the donor base stations 30 and has a function that manages and certifies movements of individual terminal devices 10 via the donor base stations 30, and manages processing for setting packet communication data paths, and a function that performs quality control of the radio network.

The femto core network 50 is a network for performing various kinds of management regarding the relay apparatus 20. The femto core network 50 is connected to, for example, a femto OAM (Femto Operations Administration Maintenance) 52 and has a function that operates, manages, and maintains the relay apparatus 20.

The second core network EPC 60 has, for example: a function that controls call connections to provide mobile communication services or controls the services; a function that serves as a switching station to receive calls from external networks such as the Internet 70 to contract subscribers in the radio network or subscribers who are roaming in the radio network; a function that manages and certifies movements of the individual terminal devices 10 in the second core network EPC 60 and manages processing for setting packet communication data paths; and a function that performs communication policy control such as quality control and performs control pursuant to billing rules.

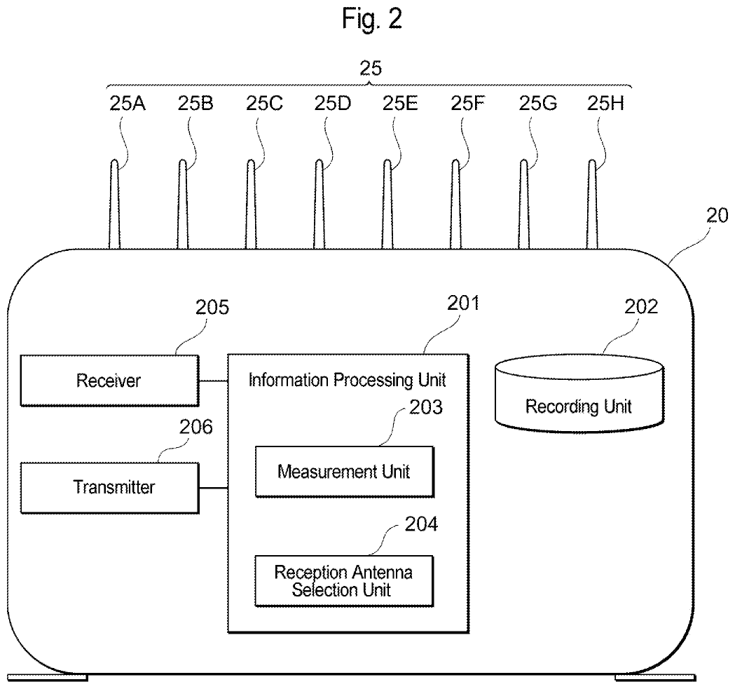

FIG. 2 is a configuration diagram of a relay apparatus according to an embodiment. Referring to FIG. 2, the relay apparatus 20 illustratively includes: an information processing unit 201 that executes information processing for relaying communication between the terminal devices 10a and the donor base stations 30; a recording unit 202 that records frequency bands for communications and antennas selected by a reception antenna selection unit 204 described later with respect to at least each one of the donor base stations 30 to communicate; a receiver 205 that receives a signal from the donor base station 30 by using the antennas 25; and a transmitter 206 that transmits the signal to the donor base station 30 by using the antennas 25. The information processing unit 201 functionally includes a measurement unit 203 and the reception antenna selection unit 204.

The measurement unit 203 measures the reception status of a signal received from one donor base station 30 from among a plurality of donor base stations 30 while changing a combination of a plurality of antennas 25A to 25H to be used. For example, the measurement unit 203 judges the reception status of the signal on the basis of a specified physical quantity, for example, whether a reception signal level (reception intensity) of the signal received from the one donor base station 30 is high or low. Specifically speaking, reference is made to at least one of RSRP (Reference Signal Received Power) and RSSI (Received Signal Strength Indicator) as the reception signal level.

The RSRP is a basic parameter for evaluating the reception signal level of radio waves from the donor base station and is an index whose level changes considerably depending on the selected combination of antennas 25A to 25H. This is because directivity regarding transmission and reception of electromagnetic waves changes considerably depending on the selected combination of antennas 25A to 25H. The RSRP is determined on the basis of other factors, that is, transmission power of the donor base station, installment conditions of the donor base station including orientations and heights of the antennas 25A to 25H for the base station, and measurement environment including the distance from the donor base station and whether any obstacle(s) exists or not. The RSSI is, like the RSRP, a basic parameter for evaluating the reception signal level of radio waves from the base station. However, unlike the RSRP, the RSSI is a parameter that can change depending on not only the installment conditions and measurement environment of the donor base station, but also a traffic amount of the measurement target base station and its surrounding base stations.

The measurement unit 203 may judge the reception status of the signal by further referring to at least one of RSRQ (Reference Signal Received Quality) and SINR (Signal to Interference plus Noise power Ratio) as a physical quantity to judge the reception status.

The RSRQ is one of indexes representing reception quality of radio waves from the donor base station and is a parameter calculated based on a ratio of RSRP to RSSI. The SINR is a parameter representing a ratio of received signal power to interference and noise power in consideration of interference from surrounding donor base stations and other relay apparatuses.

The reception antenna selection unit 204 selects a plurality of antennas, which are to be used to receive a signal from one donor base station 30 on the basis of the reception status measured by the measurement unit 203, as reception antennas from the antenna group 25. For example, the reception antenna selection unit 204 selects a plurality of antennas, whose reception signal level of the signal to be received from the donor base station 30 is high, from the antenna group 25. According to recognition by the inventors of the present invention, the combination of antennas thus selected to realize a preferred reception status provides a preferred transmission status also upon transmission of electromagnetic waves of the same frequency.

The receiver 205 receives the signal from one donor base station 30 by using the plurality of antennas selected by the reception antenna selection unit 204.

The transmitter 206 transmits the signal to the one donor base station 30 by using the same combination of antennas as the plurality of antennas 25 used to receive the signal. Furthermore, the transmitter 206 forms a beam to transmit the signal to the donor base station 30 by using the plurality of antennas 25 selected by the reception antenna selection unit 204.

### [Reception Antenna Selection Processing]

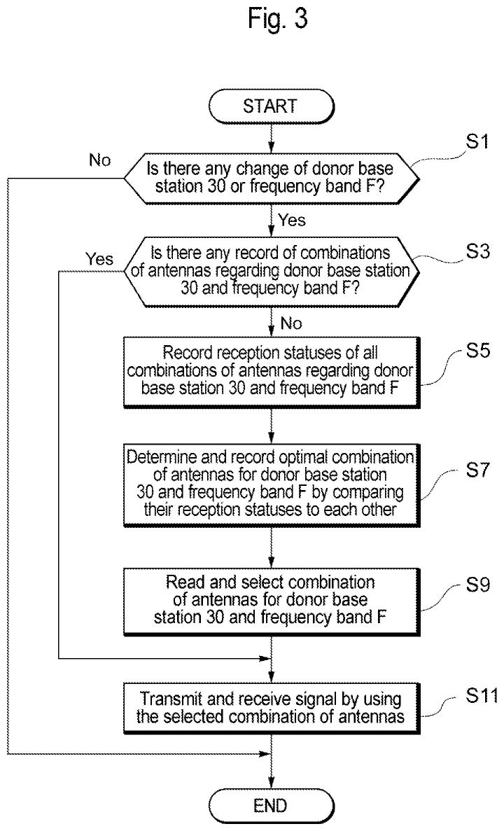

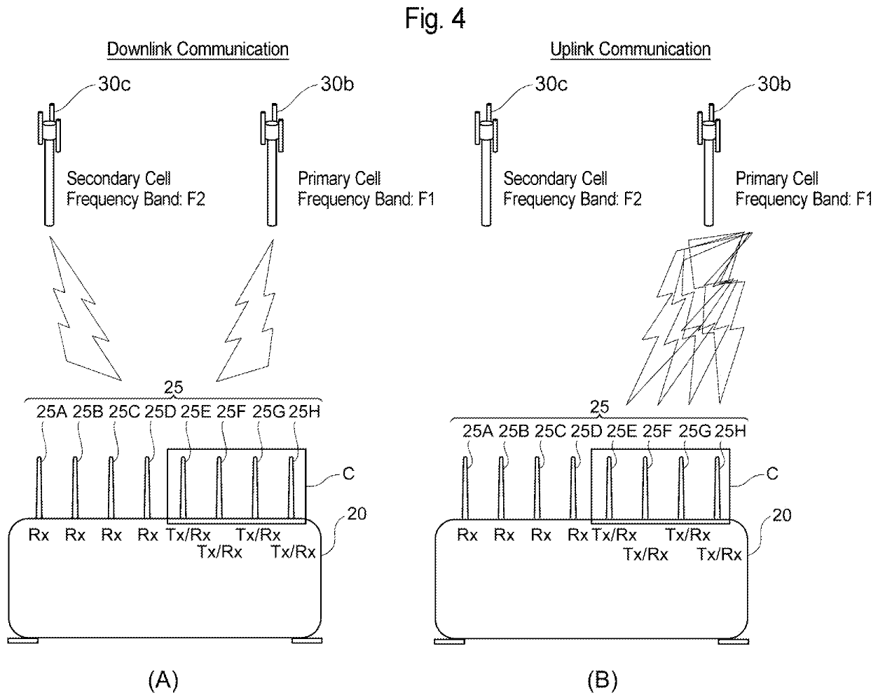

Reception antenna selection processing of the relay apparatus according to an embodiment will be explained with reference to FIG. 3 and FIG. 4. FIG. 3 is a sequence diagram for explaining a procedure for the reception antenna selection processing of the relay apparatus according to an embodiment. FIG. 4 is a schematic diagram for explaining the reception antenna selection processing of the relay apparatus according to an embodiment. FIG. 4A is a diagram illustrating downlink communication indicative of transmission of a signal from a plurality of donor base stations 30b, 30c to the relay apparatus 20, and FIG. 4B is a diagram illustrating uplink communication indicative of transmission of a signal from the relay apparatus 20 to a single donor base station 30b.

As a premise for that reception antenna selection processing flow, a user of the mobile body communication system, for example, downloads reception antenna selection processing application software according to an embodiment from a specified site on the network and saves the reception antenna selection processing application software in the relay apparatus 20 so that it can be executed. Then, when the user issues an instruction to execute the reception antenna selection processing application software, a program operation based on the reception antenna selection processing application software is started.

Firstly, while changing a combination of a plurality of antennas to be used from among the antenna group 25 constituted of the plurality of selectable antennas 25 for transmitting and receiving a signal to and from the plurality of donor base stations 30b, 30c in the plurality of different frequency bands F1, F2 as illustrated in FIG. 1, the measurement unit 203 for the relay apparatus 20 illustrated in FIG. 2 measures the reception status of the signal received from at least one macro cell base station 30b from among the plurality of donor base stations 30b, 30c. An example of processing by the measurement unit 203 will be described below.

### (Step S1 in FIG. 3)

The measurement unit 203 judges whether there is any change of the donor base stations 30b, 30c or the frequency bands F1, F2. When there is any change of the donor base stations 30b, 30c or the frequency bands F1, F2 (when Yes), the processing proceeds to step S3. On the other hand, when there is no change of the donor base stations 30b, 30c or the frequency bands F1, F2 (when No), this processing is terminated.

### (Step S3)

The measurement unit 203 judges whether or not there is any record of combinations of antennas for the donor base station 30 and the frequency band F in the recording unit 202. When there is any record of the combinations of antennas for the donor base station 30 and the frequency band F in the recording unit 202 (when Yes), the processing proceeds to step S11. Step S11 will be explained later. On the other hand, when there is no record of the combinations of antennas for the donor base station 30 and the frequency band F in the recording unit 202 (when No), the processing proceeds to step S5.

### (Step S5)

The measurement unit 203 measures reception statuses of all combinations of antennas for the donor base station 30 and the frequency band F and records the measured reception statuses in the recording unit 202. For example, the measurement unit 203 measures the reception statuses of all combinations of the plurality of antennas 25A to 25H to be used for the donor base station 30 and the frequency band F from among the antenna group 25 and records the measured reception statuses in the recording unit 202.

### (Step S7)

The measurement unit 203 compares the reception statuses of all the combinations of the plurality of antennas 25A to 25H to each other with respect to each combination of antennas, determines an optimal combination of antennas for the donor base station 30 and the frequency band F, and records it in the recording unit 202. For example, as illustrated in rectangular frame C of FIG. 4A, the measurement unit 203 prioritizes and determines a combination of antennas 25E, 25F, 25G, and 25H whose reception signal level of the signal from the donor base station 30b is high. Incidentally, the measurement unit 203 may determine at least two or more antennas from among the plurality of antennas whose reception signal level of the signal from the donor base station 30b is high, in order to receive the signal from the donor base station 30b and to transmit the signal to the donor base station 30b.

### (Step S9)

Next, referring to FIG. 4A, the reception antenna selection unit 204 illustrated in FIG. 2 selects a plurality of antennas to be used from the antenna group 25 to receive the signal from one donor base station 30b, which is a primary cell, on the basis of the reception status measured by the measurement unit 203. For example, the reception antenna selection unit 204 reads the combinations of antennas for the donor base station 30 and the frequency band F, which are recorded in the recording unit 202, and selects a combination of antennas to be used to receive the signal from the one donor base station 30b.

### (Step S11)

Referring to FIG. 4A, the receiver 205 receives the signal from the one donor base station 30b by using the combination of the plurality of antennas 25E, 25F, 25G and 25H selected by the reception antenna selection unit 204.

In the example of FIG. 4A, all the antennas 25A to 25H can operate as reception antennas Rx. In this embodiment, the antennas 25A to 25D are configured as a combination of reception antennas Rx to receive the signal from the donor base station 30c, which is a secondary cell, by using the frequency band F2. The antennas 25E to 25H are configured as a combination of reception antennas Rx to receive the signal from the donor base station 30b by using the frequency band F1 which is different from the frequency band F2.

The transmitter 206 transmits the signal to one donor base station 30b by using the same combination of antennas as the plurality of antennas 25E, 25F, 25G and 25H used to receive the signal as illustrated in the quadrangular frame C in FIG. 4B. For example, the transmitter 206 forms a beam to transmit the signal to the donor base station 30 by using the selected plurality of antennas 25E, 25F, 25G and 25H.

With the LTE TDD system under this circumstance, the same frequency is used for the downlink and the uplink. Therefore, by judging the reception signal level of the signal transmitted from a specific donor base station in a specific frequency band during the downlink communication, it is possible to appropriately select the reception antennas to receive the signal transmitted from the specific donor base station and the transmission antennas, which are common with the reception antennas, for optimal beamforming for the uplink, and it is possible to appropriately estimate the weight of each of the transmission antennas.

In this embodiment, the transmitter 206 uses the same combination of antennas as the plurality of antennas 25E, 25F, 25G and 25H, which are selected as the reception antennas Rx to receive the signal from the donor base station 30b, as the transmission antennas Tx. The transmitter 206 performs beamforming by weighting each of the antennas 25E, 25F, 25G and 25H on the basis of the reception status measured by the measurement unit 203.

### Advantageous Effects

According to an embodiment as described above, while changing a combination of a plurality of antennas to be used from among an antenna group constituted of a plurality of selectable antennas for transmitting and receiving a signal to and from a plurality of donor base stations 30b, 30c in a plurality of different frequency bands F1, F2, the reception status of a signal received from a signal from one donor base station 30b from among the plurality of donor base stations 30b, 30c is measured; the signal from the one donor base station 30b is received by using the plurality of antennas which are selected on the basis of the reception status and are used to receive the signal from the one macro cell base station 30b; and the signal is transmitted to the one donor base station 30b by using the same combination of antennas as the plurality of antennas used to receive the signal. So, when the relay apparatus which relays communication with the plurality of donor base stations in the plurality of different frequency bands relays communication between a terminal device and a donor base station, optimal antennas can be shared to receive and transmit the signal and, therefore, the communication quality can be enhanced for both the transmission and the reception.

### Other Embodiments

The present invention has been described by referring to the embodiment as described above; however, the description and drawings which constitute part of this disclosure should not be understood to limit this invention. Various substitute embodiments, examples, and techniques to be operated will be made clear for those skilled in the art on the basis of this disclosure.

### INDUSTRIAL APPLICABILITY

The aforementioned embodiment has described an example of a mobile body communication system according to the LTE standard which is the telecommunications standard for mobile body communications; however, the invention is not limited to this example and the present invention can be also applied to other telecommunications standards and any telecommunications standards to be established in future. Specifically speaking, the present invention can be applied as long as it is a system including a relay apparatus which uses different antennas for downlink and uplink and regarding which there is fear of degradation of the communication quality including communication speeds and communication reliability of the entire communication system unless specified communication quality of the relay apparatus is maintained. When communication between a terminal device and a donor base station is relayed by applying the relay method according to the present invention, optimal antennas can be shared in both transmission and reception of a signal, so that the operation and effect capable of enhancing the communication quality for both the transmission and reception can be expected.

### REFERENCE SIGNS LIST

10 terminal device
20 relay apparatus
22 access node
24 relay node
25 antennas
30 donor base station (macro cell base station)
40 first core network EPC
50 femto core network
60 second core network EPC
100 mobile body communication system
201 information processing unit
202 recording unit
203 measurement unit
204 reception antenna selection unit
205 receiver
206 transmitter

1. A relay apparatus for relaying communication between a terminal device and a macro cell base station,
the relay apparatus comprising:
an antenna group constituted of a plurality of selectable antennas for transmitting and receiving a signal to and from a plurality of macro cell base stations in a plurality of different frequency bands;
a measurement unit that measures a reception status of a signal received from one macro cell base station from among the plurality of macro cell base stations while changing a combination of the plurality of antennas to be used;
a reception antenna selection unit that selects the plurality of antennas to be used to receive the signal from the one macro cell base station on the basis of the measured reception status;
a receiver that receives the signal from the one macro cell base station by using the selected plurality of antennas; and
a transmitter that transmits the signal to the one macro cell base station by using the same combination of antennas as the plurality of antennas used to receive the signal.

2. The relay apparatus according to claim 1, wherein the reception antenna selection unit prioritizes selection of an antenna, whose reception intensity of the signal from the macro cell base station is high, from among the antenna group.

3. A relay method for relaying communication between a terminal device and a macro cell base station,
the relay method comprising the steps of:
while changing a combination of a plurality of antennas to be used from among an antenna group constituted of a plurality of selectable antennas for transmitting and receiving a signal to and from a plurality of macro cell base stations in a plurality of different frequency bands, measuring a reception status of a signal received from one macro cell base station from among the plurality of macro cell base stations;
selecting the plurality of antennas to be used to receive the signal from the one macro cell base station on the basis of the measured reception status;
receiving the signal from the one macro cell base station by using the selected plurality of antennas; and
transmitting the signal to the one macro cell base station by using the same combination of antennas as the plurality of antennas used to receive the signal.
